(19) United States
(12) Patent Application Publication
(10) Pub. No.: US 2017/0366403 A1
(43) Pub. Date: Dec. 21, 2017

(54) METHODS AND APPARATUSES FOR PERFORMING RESOURCE MANAGEMENT

(71) Applicant: ADVA Optical Networking Sp. z o.o., Gdynia (PL)

(72) Inventors: Zbigniew GAWRON, Gdynia (PL); Krzysztof PRUS, Slupsk (PL)

(21) Appl. No.: 15/625,198

(22) Filed: Jun. 16, 2017

(30) Foreign Application Priority Data
Jun. 17, 2016 (EP) 16175092.2

(51) Int. Cl. H04L 12/24; H04L 29/08

(52) U.S. Cl. CPC H04L 41/0893; H04L 41/046; H04L 67/325; H04L 67/10

(57) ABSTRACT

A method and apparatus for resource management of cloud resources comprising: (a) slicing resources, R, provided by an infrastructure provider, IP, and (b) assigning the sliced resources to different clouds according to predetermined cloud resource policies, CRPs, of the respective clouds.

### CROSS-REFERENCE TO RELATED APPLICATION

This patent application claims priority to European patent application EP 16175092.2, filed on Jun. 17, 2016, the entire disclosure of which is incorporated by reference herein.

### TECHNICAL FIELD

The disclosure herein relates to a method and apparatus for resource management of distributed cloud resources provided by an infrastructure provider to different clouds or different tenants and relates in particular to a resource broker to manage access to shared infrastructure resources according to cloud resource policies.

### BACKGROUND

FIG. 1 shows a schematic diagram of a conventional infrastructure topology of a cloud using infrastructure resources provided by an infrastructure provider IP. Cloud A comprises in the illustrated exemplary topology a control node A connected to different computation nodes A1, A2, A3 having associated hardware resources of the infrastructure provider. Each computation node A1, A2, A3 belongs to an infrastructure provider IP who offers the infrastructure as a service to the respective cloud. There can be different clouds using resources R provided by the infrastructure provider IP. A cloud does not only need network resources but also computation and storage resources which can span over multiple distributed nodes and which can vary over time.

FIG. 2 illustrates a resource allocation as performed in the conventional topology illustrated in FIG. 1. It can be seen in FIG. 2, that control node A of the cloud A does ask each of the computation nodes A1, A2, A3 for available resources of the infrastructure provider. In the given example, control node A of cloud A sends three resource inquiries RINQ to the three different computation nodes A1, A2, A3 of the infrastructure provider inquiring whether the infrastructure provider IP has available resources R. Each of the computation nodes A1, A2, A3 of the infrastructure provider IP sends a separate resource response message RRMSG to the inquiring control node A of cloud A indicating available resources R. Then, the control node A of the cloud sends three separate resource allocation requests RAREQ to the three different computation nodes A1, A2, A3 of the infrastructure provider IP. Each of the computation nodes A1, A2, A3 sends a separate associated resource allocation confirmation RACONF to the control node A of the cloud A. Accordingly, in the given example, the three different computation nodes A1, A2, A3 send three separate resource allocation confirmations RACONF to the inquiring control node A of the cloud A. After having used the assigned resources the control node A can send resource deallocation message RDMSG to a computation node of the infrastructure provider IP for instance to computation node A1 as shown in FIG. 2. After having performed the deallocation the computation node A1 can retransmit a resource deallocation confirmation RDCONF to the control node A of cloud A as illustrated in FIG. 2. The conventional resource allocation as illustrated in FIGS. 1, 2 has several drawbacks. Sharing of the same hardware resources for multiple clouds or tenants is not possible. The fixed assignment based on maximum tenant resource requirements of the different clouds is not scalable and does lead to an inefficient resource usage of the different infrastructure resources provided by the infrastructure provider IP.

### SUMMARY

Accordingly, it is an object of the present disclosure to provide a method and apparatus to provide the possibility to share efficiently resources between different clouds.

This object is achieved according to a first aspect of the present subject matter by a method as disclosed herein.

The present disclosure provides according to a first aspect a method for resource management of resources comprising:
slicing resources provided by an infrastructure provider; and
assigning the sliced resources to different clouds according to predetermined cloud resource policies of the clouds.

In a possible embodiment of the method according to the first aspect of the present disclosure each cloud comprises at least one associated cloud resource policy indicating resources obtainable by the respective cloud.

In a further possible embodiment of the method according to the first aspect of the present disclosure the cloud resource policy of a cloud is configured by a cloud administrator of the respective cloud.

In a still further possible embodiment of the method according to the first aspect of the present disclosure the cloud resource policy of a cloud comprises rules indicating a guaranteed minimum resource level of resources to be provided by the infrastructure provider for the respective cloud and/or rules indicating a maximum resource level of resources to be provided by the infrastructure provider for the respective cloud and/or rules indicating a timeout or a period of time or a time schedule for providing resources by the infrastructure provider for the respective cloud.

In a further possible embodiment of the method according to the first aspect of the present disclosure the cloud resource policies of the different clouds are negotiated and stored in a resource policy database of the infrastructure provider.

In a further possible embodiment of the method according to the first aspect of the present disclosure the cloud comprises at least one control node which sends a resource inquiry for resources of the infrastructure provider to a computation node of the infrastructure provider, wherein the computation node of the infrastructure provider forwards the received resource inquiry to a resource broker of the infrastructure provider which reads the cloud resource policy of the respective cloud from the resource policy database of the infrastructure provider.

In a further possible embodiment of the method according to the first aspect of the present disclosure the resource broker of the infrastructure provider verifies whether the resources requested by the inquiring control node of the respective cloud comply with the cloud resource policy of the respective cloud read from the resource policy database of the infrastructure provider.

In a further possible embodiment of the method according to the first aspect of the present disclosure the resource broker of the infrastructure provider sends a resource response indicating resources of the infrastructure provider which are available and which have been verified by the resource broker of the infrastructure provider to the computation node of the infrastructure provider having received the resource inquiry from the inquiring control node of the cloud, wherein the computation node of the infrastructure provider sends a resource allocation confirmation to the inquiring control node of the cloud indicating the available and verified resources.

In a further possible embodiment of the method according to the first aspect of the present disclosure the available and verified resources of the infrastructure provider as indicated in the resource allocation confirmation are allocated by the infrastructure provider to the cloud comprising the inquiring control node.

In a further possible embodiment of the method according to the first aspect of the present disclosure the resources comprise hardware resources including infrastructure hardware resources provided by the infrastructure provider.

In a further possible embodiment of the method according to the first aspect of the present disclosure the resources comprise computation resources for performing computations.

In a still further possible embodiment of the method according to the first aspect of the present disclosure the resources comprise data storage and/or memory functions.

In a still further possible embodiment of the method according to the first aspect of the present disclosure the resources comprise hypervisor resources.

In a still further possible embodiment of the method according to the first aspect of the present disclosure the resources comprise peripheral component interconnect, PCIe, resources.

In a still further possible embodiment of the method according to the first aspect of the present disclosure the resources comprise network functions, connecting computation resources to physical network interface(s) of the computation node.

The disclosure herein further provides according to a second aspect an apparatus for resource management of resources comprising the features described herein. The disclosure herein provides according to the second aspect an apparatus for resource management of resources comprising a resource broker of an infrastructure provider, the resource broker being adapted or configured to slice resources provided by the infrastructure provider and assign the sliced resources to different clouds on the basis of predetermined cloud resource policies of the respective clouds stored in a resource policy database of the infrastructure provider.

In a possible embodiment of the apparatus according to the second aspect of the present disclosure the resource broker comprises a processing unit having a policy configuration interface for configuration of cloud resource policies of different clouds using resources provided by the infrastructure provider by at least one cloud administrator of the respective clouds.

In a still further possible embodiment of the apparatus according to the second aspect of the present disclosure the resource broker of the apparatus has access to a resource policy database of the infrastructure provider for uploading configured cloud resource policies and for loading or reading cloud resource policies from the resource policy database of the infrastructure provider.

In a further possible embodiment of the apparatus according to the second aspect of the present disclosure the cloud resource policy of a cloud comprises rules indicating a guaranteed minimum resource level of resources to be provided by the infrastructure provider for the respective cloud and/or rules indicating a maximum resource level of resources to be provided by the infrastructure provider for the respective cloud and/or rules indicating a timeout or period of time or time schedule for providing resources by the infrastructure provider to the respective cloud.

### BRIEF DESCRIPTION OF THE DRAWINGS

In the following, possible embodiments of the different aspects of the present disclosure are described in more detail with reference to the enclosed figures.

FIG. 1 shows a schematic diagram of a conventional system for performing a resource management;

FIG. 2 shows schematically a signal diagram for illustrating the operation of the conventional system illustrated in FIG. 1;

FIG. 3 shows a flowchart of a possible exemplary embodiment of a method for resource management according to the first aspect of the present disclosure;

FIG. 4 shows a signal diagram for illustrating a possible exemplary embodiment of a method for performing a resource management according to the first aspect of the present disclosure;

FIG. 5 shows a block diagram for illustrating a possible exemplary embodiment of an apparatus according to the second aspect of the present disclosure;

FIG. 6 shows schematically possible exemplary embodiments of a system performing a method for resource management according to the present disclosure.

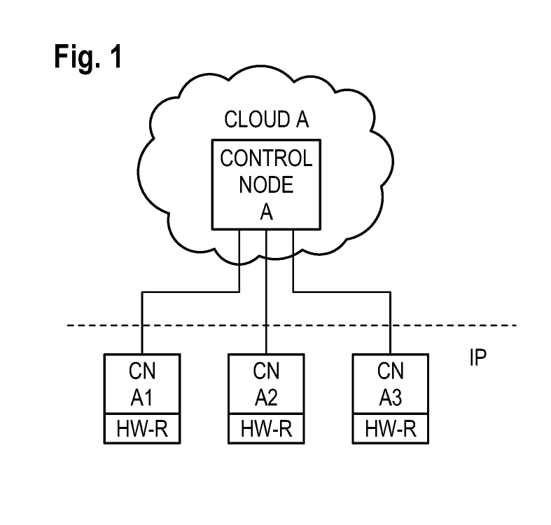

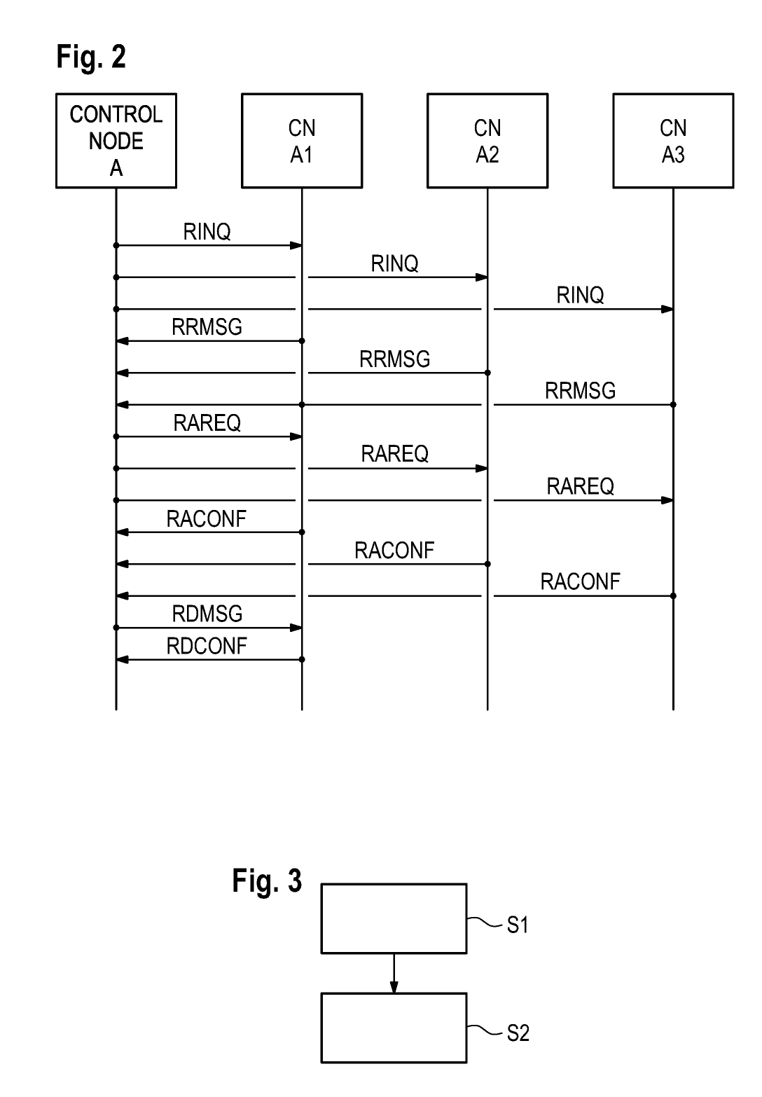

### DETAILED DESCRIPTION

As can be seen in FIG. 3, a method for performing a resource management of resources, R, according to the first aspect of the present disclosure can comprise as illustrated in the exemplary embodiment several steps. In the shown exemplary embodiment, the method for performing a resource management of resources R comprises two main steps.

In a first step S1 resources R provided by an infrastructure provider IP are sliced. A slicing of resource comprises the allocation and/or assignment of resources R at the same time as another subset of the resources R is assigned or allocated to another requestor or requesting cloud or tenant. The resources R can comprise hardware resources including infrastructure hardware resources provided by the respective infrastructure provider IP. These resources R can for instance comprise computation resources for performing computations for different clouds or tenants. These computation resources can comprise any kind of computation or calculation resources such as processing units for instance microprocessors, other computation entities. Resources R can further comprise memory or data storage resources. Resources R can further comprise hypervisor resources. A hypervisor is a software program that can manage multiple operating systems or multiple instances of the same operating system OS on a single computer system. The hypervisor manages the processor, memory and other resources R of the system to allocate what each operating system OS requires. A hypervisor can be implemented by a virtualization manager. An environment provided by the hypervisor is functionally equivalent to the original machine environment. This implies that the same operating systems, tools and application software can be used in the virtual environment. The hypervisor domain allocates the resources R of a computer domain to virtual machines VMs of software appliances. The hypervisor can be adapted or configured for public enterprise cloud requirements. The hypervisor can be used to provide virtual machines VMs and can emulate different pieces of a hardware platform. The hypervisor can emulate in a possible embodiment a complete instruction set such that a virtual machine VM gets the impression that it is running on a completely different CPU architecture than the actual CPU on which it is currently running.

The resources R further comprise peripheral component interconnect, PCIe, resources. The system can comprise components including host processors, memory controllers, media hardware accelerators or peripheral controllers. A memory controller can help a host processor to interface with a local memory peripheral controller to provide the access to all input/output 10 devices, peripheral connect interface, PCIe, slots, etc. The 10 devices are virtualized in a possible embodiment by software such as a hypervisor which enables multiple hosts of the system to share the same system resources. A hypervisor or virtual machine monitor VMM can provide a platform for isolated execution of system images and can manage access between system images and the attached IO devices of the system. For PCIe based IO virtualization multiple system images can be implemented on a single host processor of the system. The peripheral component interconnect special interest group has specified a single route input/output virtualization SR-IOV standard. SR-IOV standard can be extended to a multi-route, MR, input/output virtualization MR-IOV standard which allows virtualization of the IO devices between multiple host processors. The multi-route, MR, IO virtualization standard defines a PCIe protocol for virtualizing the peripheral devices and the routing of information between virtualized peripheral devices and multiple host processors in a multi host computing system. For instance, a multi-route MR-IOV switch can be programmed to virtualize the peripheral devices such that each host processor may have access to the peripheral devices connected to the host processor. The resources R can further comprise physical network functions connecting the computation node to the outside world. The network functions can be hosted on ASICs or FPGAs and/or on network interface cards.

The cloud can be used to provide virtual network functions VNFs over a network function virtualization infrastructure NFVI. A virtual network function is a software implementation of network functions normally realized as network appliance. The network functions virtualization infrastructure NFVI is a programmable environment where virtualized network functions VNFs are deployed. The network function virtualization infrastructure NFVI can span different locations. An infrastructure can comprise different kinds of hardware infrastructure resources for multiple clouds or tenants. A computation node which can belong to the infrastructure provider IP offers an infrastructure resource as a service to multiple tenants or clouds. For instance, in a mobile edge computation scenario computation nodes of the infrastructure provider IP can be formed by edge computation nodes. The edge nodes can comprise cell site gateways installed for instance at a cell tower hosting different mobile network operators. Each of the clouds or tenants does not only need isolated network resources but also computation resources which can span multiple virtual machines VMs and network ports and which can vary over time. Computation nodes CNs can comprise processors, memories, storages and IO devices.

In step S1 the resources R are sliced, i.e. divided or partitioned. By using a computation node CN it is possible to assign a subset of processors and/or network interfaces and/or memory resources to two or more separate clouds and to use it at the same time.

In the second step S2 of the exemplary embodiment as illustrated in the flowchart of FIG. 3 the resources R sliced in step S1 are assigned to different clouds or tenants according to predetermined cloud resource policies, CRPs, of the clouds. Each cloud or tenant can comprise in a possible embodiment an associated cloud resource policy, CRP, indicating resources R required by the respective cloud. These resources R can be provided by the infrastructure provider IP. The cloud resource policy, CRP, of the cloud can be configured in a possible embodiment by a cloud administrator CA of the respective clouds. In a possible embodiment each cloud has an associated cloud administrator CA. In the method according to the present disclosure as illustrated in the embodiment of FIG. 3 the different cloud administrators CAs of the clouds have the capability to acquire or reserve resources R on a need to have a basis, i.e. according to a current resource demand.

The cloud resource policy CRP of a cloud can comprise rules r indicating a guaranteed minimum resource level of resources R to be provided by the infrastructure provider IP to the respective cloud or tenant. The cloud resource policy CRP of a cloud can further comprise rules r indicating a maximum resource level of resources R to be provided by the infrastructure provider to the respective cloud. An infrastructure provider IP can control a full set of different resources R available to the different clouds. Each cloud or tenant can see his resource slice and can vary the number of the virtual machines VMs and interfaces within the boundaries set by the infrastructure provider IP. This further allows sharing the same hardware resources between different clouds. Further, the method or system according to the present disclosure improve the scalability of resources. A cloud resource policy CRP can be defined and redefined on an infrastructure provider level. A cloud resource policy CRP can define admissible resources R a cloud or tenant can obtain. The cloud resource policy CRP can comprise a guaranteed resource level and/or a maximum resource level so that the essential processes can be guaranteed to work. A cloud administrator CA of a cloud can request additional resources R on a best effort basis. It is possible to define cloud resource policies CRPs and/or resource licenses for different clients of the infrastructure provider IP. Not only a maximum or minimum resource level but also a timeout or period of time or a time schedule for providing resources R can be indicated by the cloud policy rules CPRs.

The cloud resource policies CRPs of the different clouds or tenants can be stored in a possible embodiment in a resource policy database of the infrastructure provider IP. In an embodiment, each cloud can comprise at least one control node which is capable of sending resource inquiries RINQ to the infrastructure provider IP. The resource inquiries RINQ can be sent by the control node of the cloud to a computation node CN of the infrastructure provider IP. In an embodiment, the computation node CN of the infrastructure provider IP can forward the received resource inquiry RINQ to a resource broker component of the infrastructure provider IP which reads the cloud resource policy CRP of the respective cloud from the resource policy database of the infrastructure provider IP. In a possible embodiment, the resource broker of the infrastructure provider IP can then verify or validate whether the resources R requested by the inquiring control node of the respective cloud comply with the cloud resource policy CRP of the respective cloud read from the resource policy database of the infrastructure provider IP. Further, the resource broker of the infrastructure provider IP can send in a possible embodiment a resource response message RRMSG indicating resources R of the infrastructure provider IP which are available and which have been verified by the resource broker of the infrastructure provider. The resource response message RRMSG can be sent by the resource broker to the computation node CN of the infrastructure provider having received the resource inquiry RINQ from the inquiring control node of the cloud. The computation node CN of the infrastructure provider IP can send then a resource allocation confirmation RACONF to the inquiring control node of the cloud indicating the available and verified resources R. The available and verified resources of the infrastructure provider IP as indicated in the resource allocation confirmation can then be allocated by a controller of the infrastructure provider IP automatically to the cloud comprising the inquiring control node.

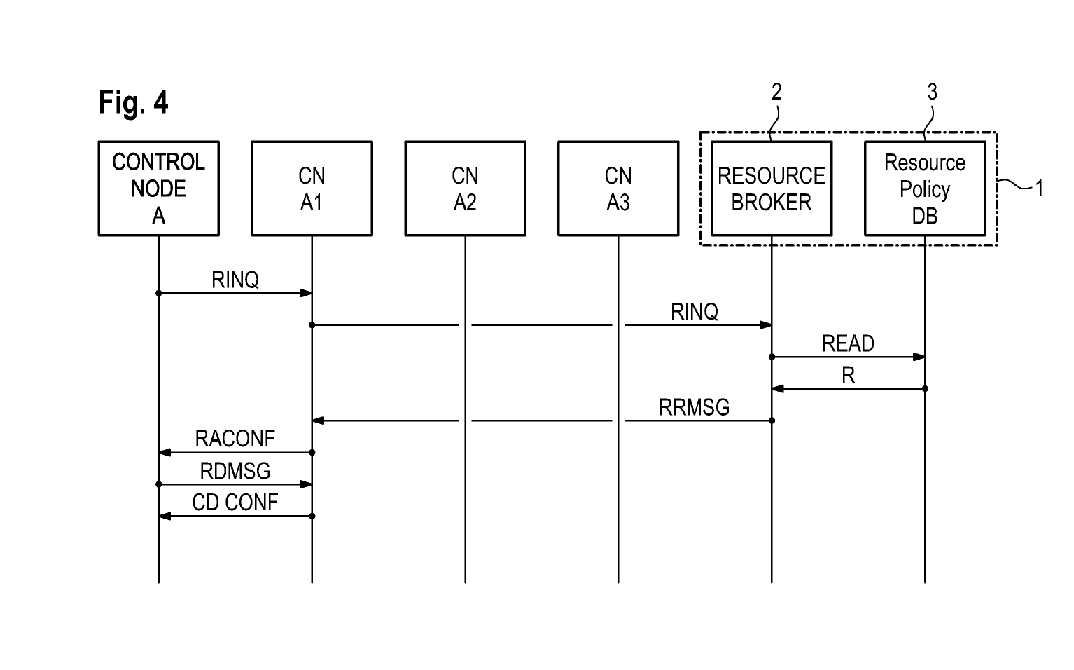

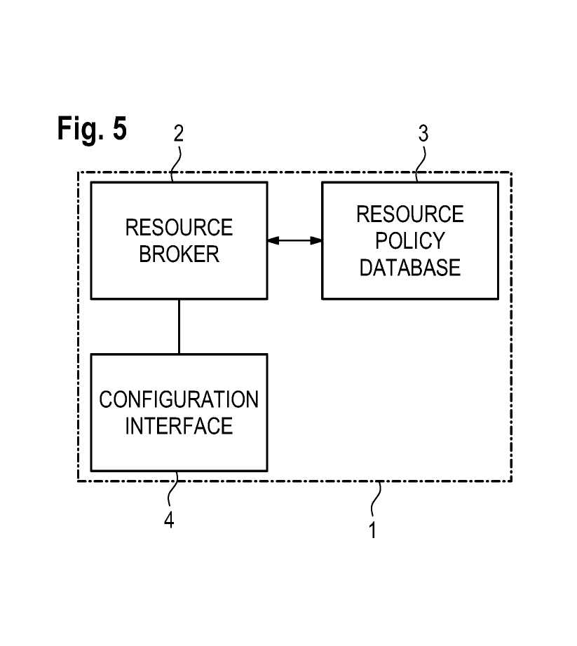

FIG. 4 shows a signal diagram illustrating a possible exemplary embodiment of a system according to the present disclosure performing a resource management according to the present disclosure. In the illustrated embodiment an infrastructure provider IP comprises three different computation nodes A1, A2, A3 which can be addressed by a control node of a cloud A as illustrated in the system of FIG. 4. The cloud can form part of a network, in particular the internet. The infrastructure provider IP further comprises a control apparatus 1 having a resource broker or resource broker control unit 2 having access to a resource policy database 3 as illustrated in FIGS. 4, 5. In the illustrated exemplary embodiment of FIG. 4, the control node A of the cloud A does first send a resource inquiry RINQ for available resources R to the computation node CN A1 of the infrastructure provider IP to ask for available resources R. The computation node CN A1 of the infrastructure provider IP forwards the received resource inquiry RINQ to the resource broker 2 of the infrastructure provider IP. The resource broker 2 has access to the resource policy database 3 of the infrastructure provider IP and reads the cloud resource policy CRP-A of the respective cloud A from the resource policy database 3 as illustrated in FIG. 4. The resource broker 2 of the infrastructure provider IP then verifies or validates whether the resources R requested by the inquiring control node of cloud A does comply or matches with the cloud resource policy CRP-A of cloud A read from the resource policy database 3 of the infrastructure provider IP. The resource broker 2 of the infrastructure provider IP then sends a resource response message RRMSG to the computation node Al of the infrastructure provider IP having received the resource inquiry RINQ from the inquiring control node A of cloud A. The resource response message RRMSG can indicate the resources R of the infrastructure provider IP which are currently available and which have been verified or validated by the resource broker 2 of the control apparatus 1 of the infrastructure provider IP according to the cloud resource policy CRP-A of cloud A. The computation node Al of the infrastructure provider IP then sends a resource allocation confirmation RACONF to the inquiring control node of cloud A indicating the available and verified resources R. If the requested resources are not available or do not comply with the cloud resource policy CRP of cloud A the control node A of cloud A gets an error message and/or a resource allocation denial message. The available and verified resources R of the infrastructure provider IP as indicated by the transmitted resource allocation confirmation RACONF can be allocated automatically by a controller of the infrastructure provider IP to cloud A comprising the inquiring control node A. Cloud A then uses the requested and allocated resources R. When the resources R are no longer needed the control node A of the cloud A can send a resource deallocation message RDMSG to the respective computation node CN of the infrastructure provider IP as shown in FIG. 4. After having deallocated the resource R computation node A1 can send a resource deallocation confirmation RDCONF to the control node of cloud A as shown in FIG. 4. The process illustrated in FIG. 4 can be performed in real-time. If the resource inquiry RINQ is denied because it does form a violation of the cloud resource policy CRP or because the infrastructure provider IP has no sufficient resources available, the tenant or client may send the RINQ to another infrastructure provider IP or modify his request. In a possible implementation, the denying first infrastructure provider IP may provide the requesting control node A of cloud A with an address of another second IP which may provide the requested resources R. In a possible implementation, if a resource request RINQ of a cloud is denied the requesting control node of the cloud receives further a message from the resource broker 2 of the infrastructure provider IP via the control node CN informing the requesting control node of the cloud about the reason why its resource request has been denied. The information message can indicate that the infrastructure provider IP has currently not sufficient resources R of a requested resource type and/or that the requested resources R do not match the cloud resource policy CRP of the requesting cloud. For instance, the number of resources R of a specific resource type requested by the control node CN of the cloud may exceed a threshold value specified in a rule r of the cloud resource policy CRP. The control node can receive also an invitation to change the current cloud resource policy CRP through a manual or automatic reconfiguration or adaption of the cloud resource policy CRP so that its resource request or resource inquiry RINQ can be fulfilled by the infrastructure provider IP. The information message can further indicate that the requested resources R are currently denied because the request does not match a timespan defined by a rule r of the cloud resource policy CRP but will be available in the future when the defined timespan has been reached. In a possible embodiment, the control nodes, the computation nodes CN and the control apparatus 1 have access to a system clock time of the system.

FIG. 5 shows a schematic block diagram with possible exemplary embodiment of an apparatus 1 according to a second aspect of the present disclosure. The illustrated apparatus 1 is adapted or configured to perform a resource management of resources R. The resources R can comprise hardware resources including infrastructure hardware resources provided by the infrastructure provider. The resources R can comprise computation resources, hypervisor resources and/or peripheral component interconnect PCIe resources. The apparatus 1 comprises in the illustrated embodiment a resource broker 2 of the infrastructure provider IP. The resource broker 2 is adapted or configured and configured to slice resources R provided by the infrastructure provider IP and to assign the sliced resources to different clouds on the basis of the predetermined rules r of the cloud resource policies CRPs of the respective clouds. In the illustrated embodiment the cloud resource policies CRPs of the different clouds are stored in a resource policy database 3 of the infrastructure provider IP. In the illustrated embodiment in FIG. 5 the apparatus 1 further comprises a configuration interface 4. The resource broker 2 can comprise at least one processing unit or microprocessor for processing messages and/or cloud resource policies CRPs. The processing unit can comprise a policy configuration interface 4 for configuration of cloud resource policies CRPs for different clouds using resources R provided by the infrastructure provider IP. The configuration can be performed by a cloud administrator CA of the respective cloud. The cloud resource policy CRP comprising a set of rules r is editable by a user through the configuration interface 4. The resource broker 2 has access to the resource policy database 3 of the infrastructure provider IP and can upload configured cloud resource policies CRPs or read or download cloud resource policies CRPs from the resource policy database 3 of the infrastructure provider IP. Each cloud resource policy CRP comprises a set of configurable resource allocation rules r which may be displayed to the editing user.

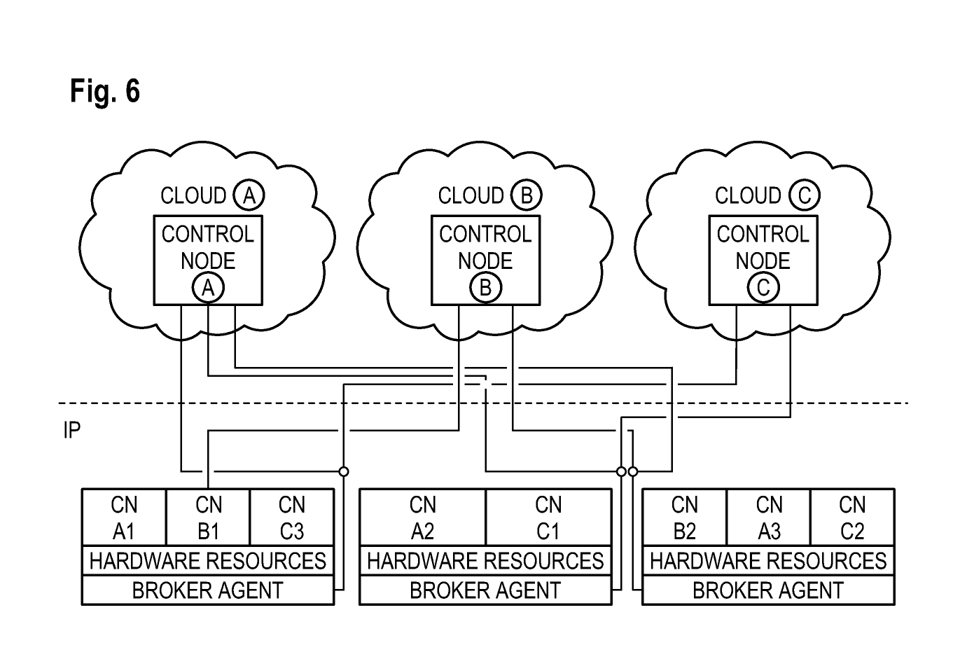

The cloud resource policies CRPs stored in the resource policy database 3 of the apparatus 1 can comprise a set of different rules r. The rules r can indicate a guaranteed minimum resource level of resources R of the same or different type to be provided by the infrastructure provider IP for the respective cloud. The rules r can further comprise rules indicating a maximum resource level of resources R to be provided by the infrastructure provider IP of the respective cloud. The rules r can also indicate a timeout or specific time after which no resources of any type or no resources of a specific type are allocated to the respective cloud. Further, rules r can indicate a period of time or timespan where resources R of the infrastructure provider IP can be allocated to the inquiring cloud. The resource broker 2 of the apparatus 1 as illustrated in FIG. 5 comprises several interfaces and/or ports for connecting the resource broker 2 of the infrastructure provider IP to the computation nodes CNs of the infrastructure provider for example to the computation nodes CN A1, CN A2, CN A3 as illustrated in FIG. 4. The resource broker 2 can be a central unit of the system or network of the infrastructure provider IP. The resource broker 2 can also be implemented in at least one computation node CN of the infrastructure provider IP. The resource policy database 3 can be a central resource policy memory or storage or a local memory implemented in the resource broker 2 of the infrastructure provider IP. The resource broker component 2 can form a broker agent with different hardware resources provided by the infrastructure provider IP as illustrated in FIG. 6. The system according to the present disclosure allows to form a usage checking of different resources R. It is further possible to share infrastructure resources R between different clouds or tenants. Further, the method and system improves the scalability of resources R. In a possible embodiment, the resource broker 2 provides a policy validation and/or verification. It is possible using the cloud resource policies CRPs to restrict resource consumption of infrastructure resources R provided by the infrastructure provider IP. The resource broker component 2 manages the cloud access to access capacity in line with the respective cloud resource policy CRP of the cloud. The resources R can in particular comprise hypervisor resources and PCIe resources. The controller of the infrastructure provider IP can control a full set of resources R and can provide sliced hypervisor and/or PCIe resources being currently available to different tenants or clouds. Each tenant or cloud can see his hypervisor resource slice and/or PCIe resource slice and can vary the number of virtual machines VMs and interfaces and storage volume within the boundaries set by the infrastructure provider IP. The system provides a higher scalability of the network function virtualized infrastructure NFVI. If different clouds transmit resource requests or resource inquiries RINQ at the same time to the infrastructure provider IP a priority of the different clouds can be specified in the cloud resource policies of the respective clouds. Alternatively, the resource request first received by the broker 2 can be handled first by the broker 2.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for resource management of cloud resources comprising:
(a) slicing resources provided by an infrastructure provider; and
(b) assigning the sliced resources to different clouds according to predetermined cloud resource policies of the clouds.

2. The method according to claim 1, wherein each cloud comprises at least one associated cloud resource policy indicating resources obtainable by the cloud.

3. The method according to claim 1, wherein the cloud resource policy of a cloud is configured by a cloud administrator of the cloud.

4. The method according to claim 1, wherein the cloud resource policy of a cloud comprises rules indicating a generated minimum resource level of resources to be provided by the infrastructure provider for the cloud and/or rules indicating a maximum resource level of resources to be provided by the infrastructure provider for the cloud and/or rules indicating a timeout, period of time, or time schedule for providing resources by the infrastructure provider for the cloud.

5. The method according to claim 1, wherein the cloud resource policies of the different clouds are stored in a resource policy database of the infrastructure provider.

6. The method according to claim 1, wherein the cloud comprises at least one inquiry control node which sends a resource inquiry for available resources of the infrastructure provider to a computation node of the infrastructure provider,
wherein the computation node of the infrastructure provider forwards the received resource inquiry to a resource broker of a control apparatus of the infrastructure provider which reads the cloud resource policy of the cloud from the resource policy database of the infrastructure provider.

7. The method according to claim 6, wherein the resource broker of the control apparatus of the infrastructure provider verifies whether the resources requested by the inquiry control node of the cloud comply with the cloud resource policy of the cloud read from the resource policy database of the infrastructure provider.

8. The method according to claim 7, wherein the resource broker of the control apparatus of the infrastructure provider sends a resource response message indicating resources of the infrastructure provider which are available and which have been verified by the resource broker of the infrastructure provider to the computation node of the infrastructure provider having received the resource inquiry from the inquiry control node of the cloud,
wherein the computation node of the infrastructure provider sends a resource allocation confirmation to the inquiry control node of the cloud indicating the available and verified resources.

9. The method according to claim 8, wherein the available and verified resources of the infrastructure provider as indicated in the resource allocation confirmation are allocated by a controller of the infrastructure provider to the cloud comprising the inquiry control node.

10. The method according to claim 1, wherein the resources comprise hardware resources including infrastructure hardware resources provided by the infrastructure provider.

11. The method according to claim 1, wherein the resources comprise:
computation resources for performing computations; and/or
hypervisor resources; and/or
peripheral component interconnect resources; and/or
data storage and/or memory and/or network resources.

12. An apparatus for resource management of resources comprising a resource broker of an infrastructure provider, the resource broker being configured to slice resources provided by the infrastructure provider and to assign the sliced resources to different clouds on a basis of predetermined cloud resource policies of the clouds stored in a resource policy database of the infrastructure provider.

13. The apparatus according to claim 12, wherein the resource broker comprises a processing unit having a policy configuration interface for configuration of cloud resource policies of different clouds using resources provided by the infrastructure provider by cloud administrators of the clouds.

14. The apparatus according to claim 12, wherein the resource broker of the infrastructure provider has access to the resource policy database of the infrastructure provider for uploading configured cloud resource policies and/or loading cloud resource policies from the resource policy database of the infrastructure provider.

15. The apparatus according to claim 12, wherein a cloud resource policy of a cloud stored in the resource policy database of the infrastructure provider comprises rules indicating a guaranteed minimum resource level of resources to be provided by the infrastructure provider to the cloud and/or rules indicating a maximum resource level of resources to be provided by the infrastructure provider to the cloud and/or rules indicating a timeout or period of time for providing resources by the infrastructure provider to the cloud.
